(19) United States
(12) Patent Application Publication
(10) Pub. No.: US 2013/0014012 A1
(43) Pub. Date: Jan. 10, 2013

(54) INTERACTIVE ELECTRONIC TECHNICAL MANUAL SYSTEM AND METHOD

(75) Inventors: Donald J. Boucher, Albuquerque, NM (US); Nathan Schmarje, Albuquerque, NM (US)

(73) Assignee: HONEYWELL INTERNATIONAL INC., Morristown, NJ (US)

(21) Appl. No.: 13/177,384

(22) Filed: Jul. 6, 2011

(51) Int. Cl. G06F 3/00

(52) U.S. Cl. 715/705

(57) ABSTRACT

Methods and systems are provided for an interactive electronic technical manual system. A system includes a user interface for receiving input from a user and providing output to the user. A database stores instructions associated with tasks. The system also includes a diagnostic reasoner for receiving commands, controlling an external device in response to the commands to implement a test of the external device, and sensing signals associated with the test of the external device. The system further includes an interface module in communication with the user interface, the database, and the diagnostic reasoner. The interface module sends instructions associated with tasks to the user interface from the database, conveys commands from the user interface to the diagnostic reasoner, receives data associated with the signals sensed by the diagnostic reasoner, and analyzes the data associated with the signals.

### STATEMENT REGARDING FEDERALLY SPONSORED RESEARCH OR DEVELOPMENT

This invention was made with Government support under W56 HZV-05-C-0724. The Government has certain rights in this invention.

### TECHNICAL FIELD

The present invention generally relates to interactive electronic technical manual (“IETM”) systems and methods, and more particularly relates to IETM systems and methods for adaptively performing maintenance tasks.

### BACKGROUND

IETM systems are well known in the art to provide instructions and guidance to persons performing maintenance tasks. These systems assist maintenance personnel in performing maintenance tasks by providing instructions in an electronic format. Also known in the art are condition based maintenance (“CBM”) products, such as diagnostic reasoners. These products interface with external devices to automatically perform maintenance tasks.

Unfortunately, there is little development in synchronizing the benefits of the IETM systems and the CBM products. Accordingly, it is desirable to provide an IETM system and method which merges the functionality of IETM systems with CBM products to provide new and advantageous results. Desirable features and characteristics of the present invention will become apparent from the subsequent detailed description of the invention and the appended claims, taken in conjunction with the accompanying drawings and this background of the invention.

### BRIEF SUMMARY

An interactive electronic technical manual system is provided for assisting in the performance of maintenance tasks. The system includes a user interface for receiving input from a user and providing output to the user. A database stores instructions associated with tasks. The system also includes a diagnostic reasoner for receiving commands, controlling an external device in response to the commands to implement a test of the external device, and sensing signals associated with the test of the external device. The system further includes an interface module in communication with the user interface, the database, and the diagnostic reasoner. The interface module sends instructions associated with tasks to the user interface from the database, conveys commands from the user interface to the diagnostic reasoner, receives data associated with the signals sensed by the diagnostic reasoner, and analyzes the data associated with the signals.

A method is provided for performing maintenance tasks. The method includes the step of receiving a request to perform a first task at a user interface. The request to perform the first task is sent to an interface module. The method also includes downloading at least a first instruction and a second instruction of the first task from a database to the interface module. The first instruction of the first task is sent from the interface module to the user interface. The method further includes receiving at the interface module an input from the user interface associated with the first instruction of the first task. The method also includes selecting based on the input associated with the first instruction of the first task one of (a) proceeding with the first task by sending the second instruction of the first task to the user interface or (b) beginning a second task by downloading at least a first instruction of a second task from the database and sending the first instruction of the second task to the user interface.

### BRIEF DESCRIPTION OF THE DRAWINGS

The present invention will hereinafter be described in conjunction with the following drawing figures, wherein like numerals denote like elements, and

FIG. 1 is a block diagram showing an embodiment of an interactive electronic technical manual (“IETM”) system; and

FIG. 2 is a flow chart showing a method for performing maintenance tasks.

### DETAILED DESCRIPTION

The following detailed description is merely exemplary in nature and is not intended to limit the invention or the application and uses of the invention. As used herein, the words “exemplary” or “illustrated” mean “serving as an example, instance, or illustration.” Thus, any embodiment described herein as “exemplary” or “illustrated” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Referring to the Figures, an interactive electronic technical manual (“IETM”) system 10 and methods are shown and described herein.

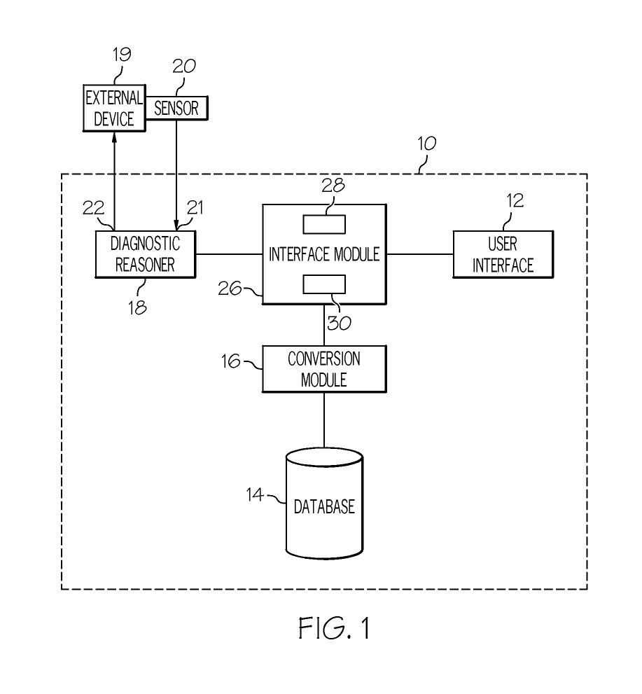

As shown in FIG. 1, the system 10 of an illustrated embodiment includes a user interface 12 for receiving input from a user and providing output to the user. The user interface 12, as described herein, refers to both the hardware and the software to interact with the user. The user interface includes at least one input device (not shown) for receiving information from the user and at least one output device (not shown) for conveying information to the user. The input device(s) may be implemented as a keyboard, a mouse, a touchscreen interface, a pushbutton, a microphone, or any other suitable device as realized by those skilled in the art. The output device(s) may be implemented as a display, a monitor, a speaker, a light, or any other suitable device as realized by those skilled in the art.

For example, in one embodiment, the user interface 12 may include a standard desktop or laptop computer (not shown) having a monitor for visual output, speakers for audio output, and a keyboard and mouse for receiving input. In another embodiment, the user interface 12 may include a tablet-style computer (not shown) with a display for visual output and a touchscreen interface for input. Of course, those skilled in the art will realize other suitable devices and programming that may be implemented as the user interface 12.

The system 10 also includes a database 14 for storing data. The database 14 may be implemented with any suitable data storage device, including, but certainly not limited to, a hard disk drive, optical disks, or memory circuits. Of course, the database 14 may be implemented as a plurality of separate databases 14. The database 14 or databases 14 may be located on a common storage device (not shown) or on separate storage devices.

The database 14 of the illustrated system 10 stores various instructions associated with maintenance tasks. The instructions may be stored in the database 14 in any number of formats. For example, the instructions may be in flat ASCII or Unicode text files, in portable document format (“PDF”) files, in markup language files (e.g., HTML, XML, SVG), or Microsoft Word format files. Of course, other formats may be utilized to store the instructions in the database 14 as readily appreciated by those skilled in the art.

The system 10 of the illustrated embodiment includes a conversion module 16 in communication with the database 14. The conversion module 16 converts the files containing the instructions into files having a standardized format. For example, if the instructions associated with one maintenance task are stored in a PDF file and the instructions associated with another maintenance task are stored in a Microsoft Word file, then the conversion module 16 converts each of these files into the same, standardized format. However, the system 10 may be implemented without the conversion module 16, e.g., in a situation where all of the instructions are already in a standardized format.

The system 10 also includes a diagnostic reasoner 18. The diagnostic reasoner 18 may be referred to as a diagnostic reasoner, a prognostic reasoner, or a condition based maintenance (“CBM”) product by those skilled in the art. One example of a diagnostic reasoner 18 is the Platform Soldier Mission Readiness System (“PS-MRS”) developed by Honeywell International Inc. of Phoenix, Ariz. The diagnostic reasoner 18, as described herein, refers to both the hardware and the software necessary for implementation, as is appreciated by those skilled in the art. Specifically, the diagnostic reasoner 18 of the illustrated embodiment includes one or more software programs operating on a microprocessor (not shown) capable of storing and executing the software program(s).

The diagnostic reasoner 18 interacts with an external device 19 to perform a test or tests on the external device 19. Specifically, the diagnostic reasoner 18 receives a command or commands, controls the external device 19 in response to the command(s), and senses signals from at least one sensor 20 associated with the external device 19.

For example, the external device 19 may be a two-way radio (not separately numbered). The diagnostic reasoner 18 may test the transmission and reception capabilities of the radio at a plurality of frequencies. As such, the diagnostic reasoner 18 includes at least one sensor input 21 for interfacing with the at least one sensor 20 and at least one control output 22 for interfacing with the external device 19 to control the external device 19. That is, the diagnostic reasoner 18 may control the external device 19 with the at least one control output 22 and receive input via the at least one sensor input 21.

As alluded to above, the at least one sensor 20 is electrically connected to the at least one sensor input 21 of the diagnostic reasoner 18 to provide sensor readings, i.e., sensor data, to the diagnostic reasoner 18. More specifically, the sensor 20 or sensors 20 of the illustrated embodiment senses conditions associated with the external device 19. Using the example of the two-way radio above, the sensor 20 may be a wireless signal detector to determine if radio frequency (RF) signals are being generated by the two-way radio. Of course, those skilled in art realize numerous other examples of the sensor 20 depending on the external device 19 and the particular condition to be tested.

The diagnostic reasoner 18 may also be utilized to trigger a built-in test of the external device 19. The term “built-in test” is often alternately referred to as a “built-in self-test” or “on-board diagnostics” by those skilled in the art. For example, the external device 19 may an instrument panel (not shown) for a vehicle. The instrument panel may include a plurality of gauges controlled by a controller. The controller of the instrument panel may cycle the gauges through a plurality of positions and ensure that the gauges show the proper positioning. The controller may then report back to the diagnostic reasoner 18 as to the result of the built-in test.

The system 10 further includes an interface module 26. The interface module 26 is implemented with a software program executable on a microprocessor (not shown). The interface module 26 is in communication with the user interface 12, the database 14 (e.g., via the conversion module 16), and the diagnostic reasoner 18. The interface module 26 receives instructions associated with tasks from the database 14 and sends those instructions to the user interface 12, conveys commands from the user interface 14 to the diagnostic reasoner 18, receives data associated with the signals sensed by the diagnostic reasoner 18, and analyzes the data associated with the signals. Furthermore, the interface module 26 performs other functions and operations as described herein.

Said plainly, the interface module 26 controls all communications between the user interface 12, the database 14, and the diagnostic reasoner 18. In the illustrated embodiment, the interface module 26 is in communication with the conversion module 16, which is in communication with the database 14. The user interface 12 of the system 10 does not communicate directly with the database 14 or the diagnostic reasoner 18. Likewise, the diagnostic reasoner 18 of the system 10 does not communicate directly with the user interface 12 or the database 14. Instead, all commands, requests, and data transmission are handled by the interface module 26 and its associated software. As such, the diagnostic reasoner 18 is not “concerned” with the specific input entered by the user at the user interface 12. That is, the diagnostic reasoner 18 need not process the data going to and from the user interface 12. Instead, the diagnostic reasoner 18 receives all of its commands from the interface module 26 which filters unnecessary and extraneous data and commands from the user interface 12.

The interface module 26 of the illustrated embodiment includes an input command parser 28 and a database content parser 30. The parsers 28, 30 are each implemented as a unit of software that is part of the interface module 26. The input command parser 28 receives all of the input commands received by the interface module 26. After the input commands are received, the input command parser 28 determines whether those commands are associated with the diagnostic reasoner 18 or the user interface 12. That is, the input command parser 28 parses all incoming commands. The database content parser 30 parses the data from the database 14. That is, the database content parser 30 separates instructions that must be viewed by the user on the user interface 12 from instructions that may be implemented as commands deliverable to the diagnostic reasoner 18. The database content parser 30 may also format the instructions downloaded from the database into a predetermined format.

Once the input commands and the data is parsed by the parsers 28, 30, the input command parser 28 then processes content, i.e., data, from the database 14 based on the commands. If the content processed is a command for the diagnostic reasoner 18, then that command is sent to the diagnostic reasoner 18. Conversely, if that content is not a command for the diagnostic reasoner 18, i.e., the content is an instruction for the user, then that content is sent to user interface 14 to be presented to the user.

As previously stated, the interface module 26 accepts various requests from the user interface 12. Specifically, the interface module 26 of the illustrated embodiment may receive commands from the user interface 12 for (a) a request for a table of contents of maintenance tasks stored in the database 14, (b) a request for the formatted contents of a maintenance task or tasks stored in the database 14, (c) a request to view a next page of contents of a particular maintenance task or tasks, (d) a command for the diagnostic reasoner 18, e.g., a built-in test request, and (e) an internal command for the interface module 26.

The interface module 26 also sends and receives various data and commands from the diagnostic reasoner 18. A command being sent to the diagnostic reasoner 18 is typically a formatted command for the diagnostic reasoner 18 to perform a specific action. Data sent from the diagnostic reasoner 18 to the interface module 26 may include, but is not limited to, (a) a response to a command, (b) an indication of whether or not a maintenance action is being performed, (c) the results of a maintenance action, and (d) an indication of the specific maintenance tasks that may be performed to resolve a problem.

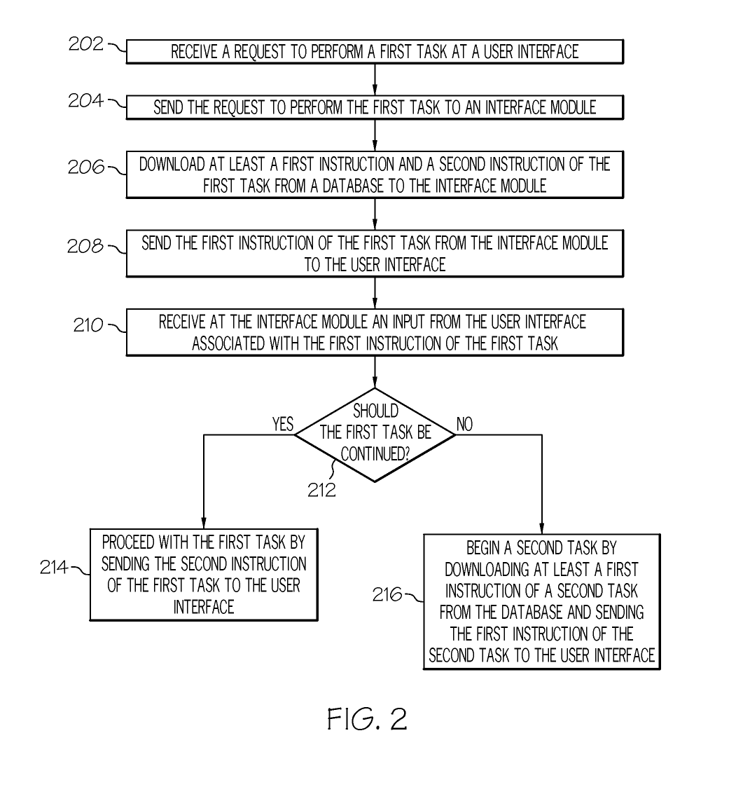

The interface module 26 of the illustrated embodiment is programmed to perform methods of performing maintenance tasks, as alluded to above. Referring now to FIG. 2, the method begins in block 202 by receiving a request to perform a first task at the user interface 12. That is, the user inputs that they are ready to perform the first task utilizing the user interface 12.

The method continues in block 204 by the user interface 12 sending the request to perform the first task to the interface module 26. Simply put, a command is sent from the user interface 12 to the interface module 26 requesting that the first task is performed. In response to this request, the instructions of the first task are downloaded from the database 14 to the interface module 26, as shown in block 206. These instructions include at least a first instruction and a second instruction. These instructions may be parsed by the database content parser 30 as described above.

In block 208, the interface module 26 then sends the first instruction of the first task to the user interface 12. An input associated with the first instruction of the first task is then received at the user interface 12 in block 210. For example, the instruction may state “remove and inspect spark plug” for an engine. The display of the user interface 12 may show a plurality of spark plug conditions such as “normal”, “worn”, “carbon deposits”, or “oil deposits”. The user then removes the spark plug and inspects it. The user is then able to input the condition of the spark plug into the user interface 12.

The input received from the user at the user interface 12 is then sent to the interface module 26. In one embodiment, the interface module 26 then selects the appropriate manner in which to proceed based on the input from the user. When a determination is made to continue the first task, in block 212, the interface module 26 will proceed with the first task by sending the second instruction of the first task to the user interface 12 in block 214. When a determination is made not to continue the first task, the interface module 26 will begin a second task by acquiring one or more instructions of the second from the database 14 and sending a first instruction of the second task to the user interface 12 in block 216. That is, the interface module 26 may temporarily or permanently abandon the first task and start a second task.

For example, in the case of the spark plugs described above, if the spark plug condition is “normal”, the interface module 26 may simply continue with the second instruction of the first task, e.g., reinstalling the spark plug. However, if the spark plug condition is “oil deposits”, it may be a sign of an oil leak in the engine. As such, the first task may be abandoned and a second task, e.g., to inspect for oil leaks within the engine, is initiated.

In another embodiment, the interface module 26 may select the appropriate manner to proceed based on data and/or results provided by the diagnostic reasoner 18. In this embodiment, a command is conveyed from the user interface 12 to a diagnostic reasoner 18 via the interface module 26 in response to the input associated with the first instruction of the first task being received. For example, the first instruction of the first task may require that the external device 19 perform a built-in test and provide the user the ability to start the built-in test. Once selected by the user, a command is sent from the user interface 12 to the interface module 26, which in turn sends a command to the diagnostic reasoner 18. In response to the command being received at the diagnostic reasoner 18, the diagnostic reasoner 18 then controls the external device 19 in accordance with the command.

Next, signals associated with the testing of the external device 19 are received by the diagnostic reasoner 18. These signals may be provided by the at least one sensor 20 associated with the external device 19 or by the external device 19 itself, in the case of a built-in test. Data associated with these signals is sent from the diagnostic reasoner 18 to the interface module 26. The interface module 26 then analyzes the data to determine the next course of action. As such, the interface module 26 then selects either to proceed with the first task or to begin the second task based on the data associated with the signals from the diagnostic reasoner 18.

When the interface module 26 selects to begin the second task, it may abandon the first task or put the first task on hold. If put on hold, the method may return to the first task after completion of the second task. Also, in a fashion similar to the interruption of the first task in favor of the second task as described above, the second task may also be interrupted in favor of a third task.

The methods provided by the interface module 26 of the illustrated embodiment include managing content that includes logic element conditionals, lists, and loops. For example, if the external device 19 is a circuit breaker (not shown) to be tested, and there are a plurality of circuit breakers that need to be tested, the interface module 26 may prompt the user, via the user interface 12 to test each circuit breaker individually and input the results of the test for each individual circuit breaker. However, depending on the circuit breaker under test, the results of the test, and its defined interconnections, only a subset of additional circuit breakers may require the test.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of performing maintenance tasks, said method comprising the steps of:
receiving a request to perform a first task at a user interface;
sending the request to perform the first task to an interface module;
downloading at least a first instruction and a second instruction of the first task from a database to the interface module;
sending the first instruction of the first task from the interface module to the user interface;
receiving at the interface module an input from the user interface associated with the first instruction of the first task; and
selecting based on the input associated with the first instruction of the first task sent one of (a) proceeding with the first task by sending the second instruction of the first task to the user interface or (b) beginning a second task by downloading at least a first instruction of a second task from the database and sending the first instruction of the second task to the user interface.

2. A method as set forth in claim 1 further comprising the step of returning to the first task after completion of the second task.

3. A method as set forth in claim 1 further comprising the step of conveying a command from the user interface to a diagnostic reasoner via the interface module in response to the input associated with the first instruction of the first task.

4. A method as set forth in claim 3 further comprising the step of controlling an external device in accordance with the command.

5. A method as set forth in claim 4 further comprising the step of sensing signals at the diagnostic reasoner associated with a test performed in accordance with the command.

6. A method as set forth in claim 5 wherein the signals are provided by one or both of the external device and at least one sensor associated with the external device.

7. A method as set forth in claim 5 further comprising the step of sending data associated with the signals from the diagnostic reasoner to the interface module.

8. A method as set forth in claim 7 further comprising the step of analyzing the data associated with the signals from the diagnostic reasoner at the interface module.

9. A method as set forth in claim 7 wherein said step of selecting is further defined as selecting one of (a) proceeding with the first task by sending the second instruction of the first task to the user interface or (b) beginning the second task by acquiring the first instruction of the second task from the database and sending the first instruction of the second task to the user interface based on the data associated with the signals from the diagnostic reasoner.

10. A method as set forth in claim 1 further comprising the step of formatting the instructions downloaded from the database into a predetermined format with a content parser.

11. A method of performing maintenance tasks, said method comprising the steps of:
receiving a request to perform a first task at a user interface;
sending the request to perform the first task to an interface module;
downloading at least a first instruction and a second instruction of the first task from a database to the interface module;
sending the first instruction of the first task from the interface module to the user interface;
receiving at the interface module an input associated with the first instruction of the first task from the user interface;
conveying a command from the user interface to a diagnostic reasoner via the interface module in response to the input associated with the first instruction of the first task;
controlling an external device in accordance with the command;
sensing signals at the diagnostic reasoner associated with a test performed in accordance with the command;
sending data associated with the signals from the diagnostic reasoner to the interface module;
analyzing the data associated with the signals from the diagnostic reasoner at the interface module; and
selecting based on the data associated with the signals from the diagnostic reasoner one of (a) proceeding with the first task by sending the second instruction of the first task to the user interface or (b) beginning a second task by downloading at least a first instruction of a second task from the database and sending the first instruction of the second task to the user interface.

12. A method as set forth in claim 11 wherein said step of sensing signals is further defined as sensing signals at the diagnostic reasoner provided by one or both of the external device and at least one sensor associated with the external device.

13. An interactive electronic technical manual system for assisting in the performance of maintenance tasks, said system comprising:
a user interface for receiving input from a user and providing output to the user;
a database storing instructions associated with tasks;
a diagnostic reasoner for receiving commands, controlling an external device in response to the commands to implement a test of the external device, and sensing signals associated with the test of the external device; and
an interface module in communication with said user interface, said database, and said diagnostic reasoner for sending instructions associated with tasks to said user interface from said database, conveying the commands from said user interface to said diagnostic reasoner, receiving data associated with the signals sensed by said diagnostic reasoner, and analyzing the data associated with the signals.

14. A system as set forth in claim 13 wherein said interface module includes a database content parser in communication with said database for parsing the instructions from said database to separate instructions that must be viewed by the user on the user interface from instructions that may be implemented as commands deliverable to said diagnostic reasoner.

15. A system as set forth in claim 13 wherein said interface module includes an input command parser for receiving the commands received by said interface module and determining whether the commands are associated with said diagnostic reasoner or said user interface.

16. A system as set forth in claim 13 further comprising a conversion module in communication with said database and said interface module for converting files of said database into files having a standardized format.
